(19) United States
(12) Patent Application Publication
(10) Pub. No.: US 2011/0052345 A1
(43) Pub. Date: Mar. 3, 2011

(54) FASTENING MEANS AND ARTICLES FORMED USING THE SAME

(76) Inventor: Lee Barker, Shipley (GB)

(21) Appl. No.: 12/937,071

(22) PCT Filed: Apr. 9, 2009
(86) PCT No.: PCT/GB09/00938

§ 371 Date: Oct. 29, 2010

(30) Foreign Application Priority Data
Apr. 11, 2008 (GB) 0806577.3

(51) Int. Cl. F16B 35/04; B23P 11/00

(52) U.S. Cl. 411/393; 29/525.01

(57) ABSTRACT

The invention relates to a fastening means for use in joining components together and/or providing a ground or earth connection. The fastening means includes a formation (28), typically provided on the underside (30) of the head (24) of the fastening means. The formation is provided such that when the fastening means is driven into a component, the formation pierces through at least one layer (8) of material of the component to substantially separate a portion of the material from the remainder of the layer. This can be used to allow the remainder of the material to be removed and/or connection with an underlying layer to be achieved.

The invention to which this application relates is a fastening means of a type which can be used to secure a first article to another article, typically by rotating the fastening means to engage a thread formed in the same with an aperture which may be threaded in said article.

There are numerous forms of fastening means currently available which allow one item to be secured to another item. A common problem which is encountered is that the fastening means themselves, and/or tools used to secure the fastening means in position, can cause damage to the article or articles which are being secured together. Furthermore, in many instances, in particular during mass manufacturing processes, the articles themselves may be susceptible to damage. In particular, relatively expensive surface finishes or surface finish effects on said articles are susceptible to damage.

As a result of this problem, it is commonly the case that at least part of said articles may be provided with a protective coating which is maintained in position during the manufacturing process and is only removed at the time of final packaging. While it is found that the provision of these coatings does greatly reduce the risk of damage to the article, the process of having to remove the protective coating adds time to the manufacturing process. This is particularly the case in circumstances where the protective coating is required to be removed and parts of the same are trapped in position by fastening means. This then renders the protective coating adjacent the fastening means difficult and time consuming to remove so that it is no longer visible and therefore adds additional time to the overall manufacturing procedure which represents additional costs, can represent a bottle neck in the manufacturing process and can also be frustrating to the operators. Indeed it is also possible that the attempts to remove the trapped protective coating, can cause damage to the very same article surfaces which the protective coating was originally provided to protect.

This problem has been identified by the applicant and the aim of the present invention is therefore to provide an ability to reduce these problems whilst, at the same time, ensuring that the visual appearance of the articles is not adversely affected.

In a first aspect of the invention, there is provided a fastening means, said fastening means having a shaft, a head portion connected to one end of the shaft, said head portion having a top face and an opposing underside, said underside moving towards at least one component as the fastening means is driven into the same and wherein said fastening means is provided with a formation to pierce into at least one layer of material on said component when the formation comes into contact with said component.

In one embodiment, the said formation is provided to rotate along with the rotation of the head portion as the fastening means is driven into position so as to pierce through and define a portion of the said at least one layer of material which is substantially separated from the remainder of the layer.

Typically the formation is positioned on the underside of the head of the fastening means and the portion of the material underlies the head and is smaller than the area of the head in plan, so that the separated portion is not externally viewable.

In one embodiment, the formation is provided as an integral part of the head and typically the head, formation and shaft are provided as integral parts.

Typically the formation has a leading edge or tip, said leading edge being placed at a distance from the underside of the head, and in advance of the same with respect to the direction of driven movement, such that the leading edge or tip contacts the layer of material in advance of the underside of the head. This also ensures that there is a sufficient gap to allow the layer of material which underlies the periphery of the head to be slid away and removed.

In one embodiment the formation defines a circular ring and the area of the head which lies between the formation and the shaft is recessed such as to receive and accommodate the separated portion of the layer of material therein. Typically the depth of the recess from the leading edge or tip of the formation is less than the distance from the leading edge or tip to the underside of the head. This arrangement means that even if the formation is moved so as to pierce into the component into which the same is driven there will still be a sufficient gap between the underside at the periphery of the head and the component to allow the layer of material from which the portion has been separated, to be removed.

In one embodiment, the head portion is provided with a drive formation which may be provided on the top face and/or side walls of the head portion for the engagement of a drive tool therewith to allow the fastening means to be rotatably driven into a fastening position.

In one embodiment, the shaft of the fastening means is threaded.

In one embodiment, at least one layer of material is pierced and a disc is formed in the same. Typically this layer is a protective coating layer and, once the fastening means is placed in position, the protective coating layer surrounding the fastening means can be easily removed as the same is free from the fastening means and is separated from the portion of the protective coating layer which is trapped in position by the head of the fastening means.

In one embodiment, the formation extends around the underside of the head of the fastening means or alternatively, can be provided as a projection at one point or a plurality of projections at spaced points on the underside of the head.

In one embodiment, the fastening means is provided as a single part component.

In one embodiment, the components to be joined together are a base casing for an electronic device and a cover for the same which, when joined together, form the article in the form of an outer housing. In one embodiment, the cover is provided with a particular surface coating which is required to be protected during manufacture and to which the protective coating layer is applied and which is only removed at the end of the assembly procedure, and typically after testing has occurred, which testing typically requires the fastening means to already have been inserted in position.

In one embodiment the fastening means pierces through a decorative surface coating to contact a conductive layer of material. In this embodiment of the invention the fastening means is used to provide an effective ground earth connection for the article which is formed.

In a further aspect of the invention there is provided a method for forming an article using fastening means to fasten components of the article together, said fastening means having a head connected to a shaft portion and a formation is provided on the underside of the head portion thereof, moving said fastening means into a fastening position for said components and continuing to move said fastening means so that the formation on the underside of the head, contacts with at least one component to pierce through at least a layer of material on the same.

In one embodiment the piercing through of the at least one layer is performed to separate a portion of the layer underlying the head, from the remainder of the layer. This, in one embodiment, allows the subsequent removal of the said remainder of the layer. In one embodiment the layer is a protective coating layer.

In one embodiment, the formation is provided so as to form a disc in a protective coating layer which is separated from the reminder of the protective coating layer.

In one embodiment the formation is caused to pierce through at least one layer of material to make contact with a further layer underlying the same and allow a ground or earth connection to be achieved.

Specific embodiment of the invention are now described with reference to the accompanying drawings wherein;

FIG. 1 illustrates an article with components joined together using fastening means in accordance with one embodiment of the invention;

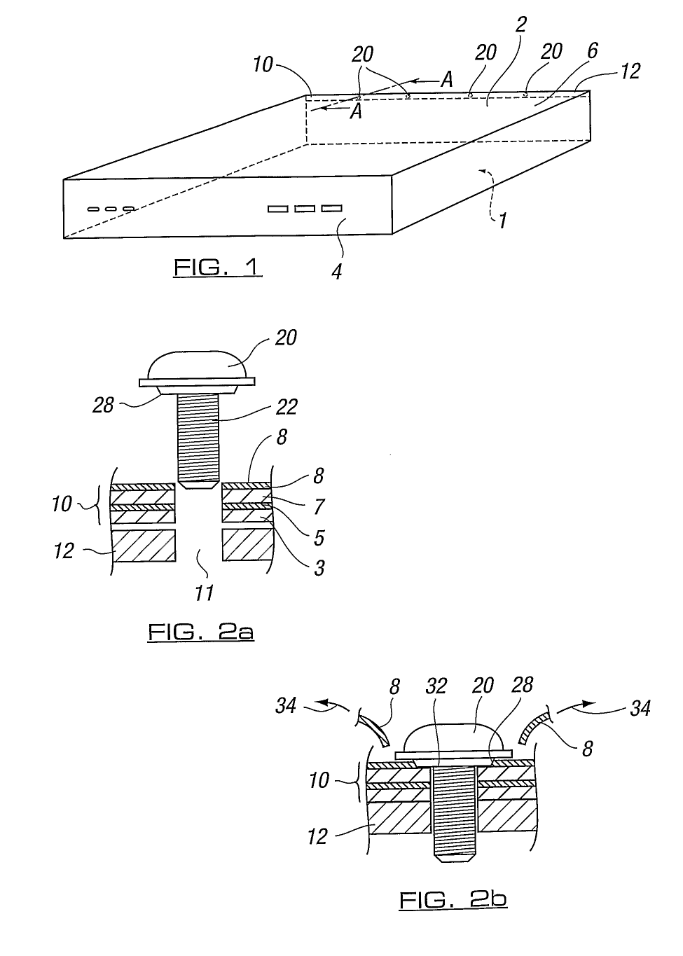

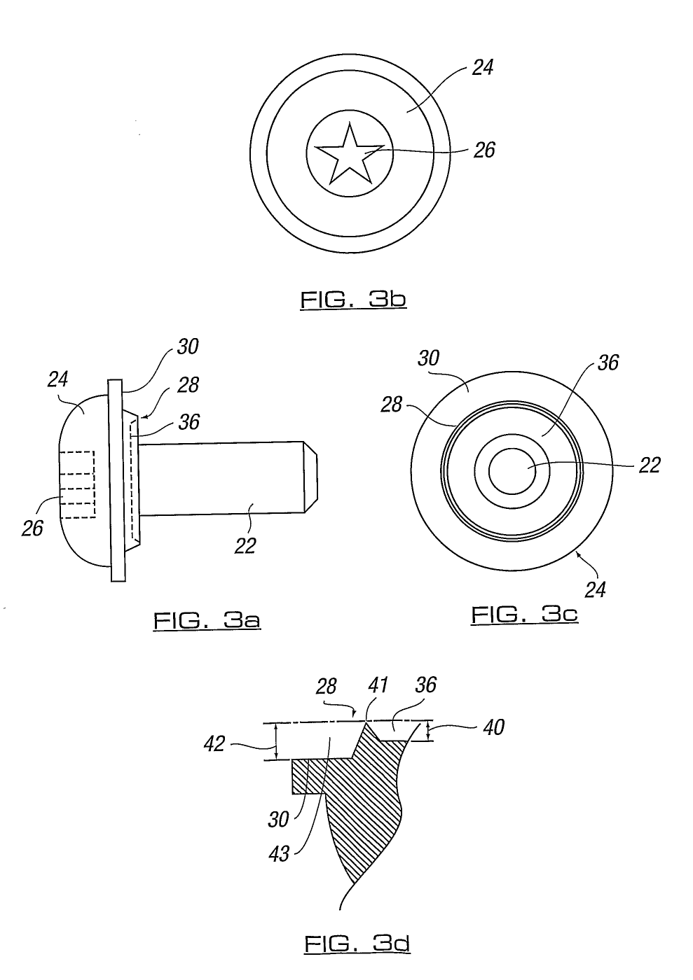

FIG. 2a illustrates parts of said article of FIG. 1 with the fastening means in the first position;

FIG. 2b illustrates the parts of the article of FIG. 2a with the fastening means in a fastening position; and

FIGS. 3a-d illustrate one embodiment of the fastening means.

Referring firstly to FIG. 1 there is illustrated a broadcast data receiver 2 (also referred to as a set top box) which is now described, in a non limiting manner, as an example of an electrical article suited for potential use of the fastening means in accordance with the invention.

The broadcast data receiver is provided to receive data from a remote location and to process the same and, typically, to allow user services such as for example television and radio programs to be generated. The article comprises a front panel 4 located on a base 1 and onto which a cover 6 is secured. In this case the cover 6 has an external surface which has an attractive or decorative appearance. In one known form, the cover is coated with a material, which is relatively susceptible to damage during manufacture of the article. As a result of this, the external surface of the cover is provided with a protective coating layer 8 during the manufacturing process. The protective coating layer is maintained in position during manufacturing, assembly and testing until the final packaging stage of the article, at which stage, the protective coating layer is required to be removed. Removal of the protective coating layer is relatively straight forward by peeling the same, except at those areas where the same is trapped in position under the heads of the respective fastening means which are driven through apertures in the cover and base to join the same together. The fastening means are typically located at the edges of the cover and base, as shown in FIG. 1, where the fastening means 20 are located at the rear edge 10 of the cover and edge 12 of the base. The fastening means are typically required to be driven into position prior to the removal of the protective coating for assembly and/or testing requirements.

Conventionally, the provision of these fastening means with their heads on the protective layer means that portions of the protective layer adjacent thereto are effectively trapped between the fastening means head and the component and it can become difficult for the operator to be able to remove all parts of the material so that the material is no longer viewable. This represents a significant bottle neck in the manufacturing process.

Referring now to FIGS. 2a and b, there is illustrated a cross sectional view along line A-A of a fastening means being moved into position. There is shown the edge 12 of the base overlaid by the edge 10 of the cover 6 of the article. In FIG. 2a the cover comprises layers of steel 3, acrylic 5 and PVC coating 7 overlaid by the protective coating layer 8. An aperture 11 is provided into which a fastening means 20 in accordance with the invention is to be secured.

The fastening means is shown in one embodiment in more detail in FIGS. 3a-d and comprises a threaded shaft 22 connected to a head portion 24 which is provided with a drive formation 26 to allow the fastening means to be engaged by a tool and driven into the fastening position shown in FIG. 2b.

On the underside or under face 30 of the head portion, there is provided a formation 28 in accordance with the invention. This formation is formed such that when the fastening means is moved downwardly into position onto the components, to the position shown in FIG. 2b, the formation cuts into at least the protective layer material 8 to pierce the same. Continued rotation of the fastening means as it is being driven means that preferably, an annular disc 32 of the protective coating layer is formed which is separated from the remainder of the protective coating layer 8 which lies around and to the outside of the formation of the fastening means and which can easily be removed as indicated in FIG. 2b by arrows 34.

The separated annular disc 32 lies within the recess portion 36 which is formed on the underside of the head and which lies within the area defined between the shaft 22 and the formation 28 and in which recess the annular disc is retained. Typically the depth 40 of the recess from the leading edge or tip 41 of the formation is less than the distance 42 from the leading edge or tip to the underside 30 at the periphery of the head. This arrangement means that even if the formation is moved so as to pierce into the component into which the same is driven there will still be a sufficient gap 43 between the underside at the periphery of the head and the component to allow the layer of material 8 from which the portion has been separated, to be removed.

In one embodiment the fastening means is driven in to a sufficient depth such that the formation pierces through a number of layers to contact with the conductive, steel layer 3. In this way a ground connection can be achieved via the fastening means which is effective and which is secured as a permanent ground connection thereby aiding the manufacture and performance of the article. It should therefore be appreciated that this is in itself a significant advantage and thus the fastening means may be used even when there is no protective layer used on the component into which the fastening means is being driven. In this embodiment the fastening means is provided to be used solely as a means for creating a good ground connection.

It will be appreciated that in certain instances, the piercing may not be sufficiently uniform so as to form an annular disc but it should equally be appreciated that any manner in which the protective coating layer underlying the head of the fastening means is separated from the remainder of the protective coating layer, is achieved, is advantageous. Thus, with the fastening means in position, the remainder of the protective coating layer can then be removed and there is no need to remove particular portions from the area adjacent the fastening means or underneath the same as the protective layer around the fastening means is detached therefrom. This therefore means that although a portion of the protective coating layer will remain in position under the fastening means head, the same is not visible and therefore does not detract from the appearance of the article.

1. A fastening means, said fastening means having a shaft, a head portion connected to one end of the shaft, said head portion having a top face and an opposing underside, said underside moving towards at least one component as the fastening means is driven into the same, said fastening means provided with a formation to pierce into at least one layer of material on said component when the formation comes into contact with said component by the driven movement of the fastening means and wherein the fastening means pierces through and defines a portion of the said at least one layer of material which is at least partially separated from the remainder of the layer to allow improved ease of separation of said portion and at least one layer of material.

2. A fastening means according to claim 1 wherein, the said formation is provided to rotate along with the rotation of the head as the fastening means is driven into position.

3. (canceled)

4. A fastening means according to claim 1 wherein the formation is positioned on the underside of the head of the fastening means and the portion of the material underlies the head.

5. A fastening means according to claim 1 wherein the formation is provided as an integral part of the head.

6. A fastening means according to claim 1 wherein the head, formation and shaft are provided as integral parts.

7. A fastening means according to claim 1 wherein the formation has a leading edge or tip, said leading edge or tip at a distance from the underside of the head and in advance of the same with respect to the direction of driven movement such that the leading edge or tip contacts the layer of material in advance of the underside of the head.

8. A fastening means according to claim 7 wherein the location of the leading edge ensures that there is a sufficient gap to allow the at least one layer of material from which the portion has been substantially separated, to be removed.

9. A fastening means according to claim 1 wherein the formation is in the shape of a ring and the area of the head underside which lies within the formation is recessed such as to receive and accommodate a portion of at least one layer of material therein.

10. A fastening means according to claim 9 wherein the depth of the recess from the leading edge or tip of the formation is less than the distance from the leading edge or tip to the underside of the head at the periphery of the head.

11. A fastening means according to claim 10 wherein there is a sufficient gap between the underside at the periphery of the head and the component to allow the layer of material from which the portion has been separated, to be removed.

12. A fastening means according to claim 1 wherein the head portion is provided with a drive formation on the top face and/or side walls of the head portion for the engagement of a drive tool therewith to allow the fastening means to be rotatably driven into a fastening position.

13. A fastening means according to claim 12 wherein the shaft of the fastening means is threaded.

14. A fastening means according to claim 1 wherein the at least one layer of material which is pierced is a protective coating layer.

15. A fastening means according to claim 14 wherein once the fastening means is placed in position, the protective coating layer surrounding the fastening means can be removed as the same is freed from the fastening means.

16. A fastening means according to claim 1 wherein the formation extends around the underside of the head of the fastening means.

17. A fastening means according to claim 1 wherein the formation is a projection at one point or a plurality of projections at spaced points on the underside of the head.

18. A fastening means according to claim 1 wherein the same is used to join together a base casing component and a cover component for an electronic device which, when joined together, form an outer housing.

19. A fastening means according to claim 1 wherein the fastening means formation is used to pierce through a material layer or layers to contact a conductive layer of material.

20. A fastening means according to claim 19 wherein the fastening means formation contact with said conductive layer of material creates a ground earth connection for the article which is formed.

21. A method of forming an article using a fastening means to fasten components of the article together, said fastening means having a head connected to a shaft portion and a formation is provided on the underside of the head portion thereof, moving said fastening means into a fastening position on said components and continuing to move said fastening means so that the formation on the underside of the head, contacts with at least one component to pierce through at least a layer of material on the same wherein a portion of the said at least one layer of material is defined which is at least partially separated from the remainder of the layer to ease the separation of said portion and at least one layer.

22. A method according to claim 21 wherein the piercing through of the at least one layer is performed to substantially separate a portion of the at least one layer underlying the head, from the remainder of the layer.

23. A method according to claim 22 wherein the layer is a protective coating layer.

24. A method according to claim 22 wherein the formation forms a portion of the layer in the form of an annular disc.

25. A method according to claim 22 wherein the formation is caused to pierce through at least one layer of material to make contact with a further layer underlying the same and allow a ground or earth connection to be achieved.
